(19) United States
(12) Patent Application Publication
(10) Pub. No.: US 2025/0267754 A1
(43) Pub. Date: Aug. 21, 2025

(54) ARTIFICIAL INTELLIGENCE BASED DISCONTINUOUS RECEPTION CONFIGURATION

(71) Applicant: QUALCOMM Incorporated, San Diego, CA (US)

(72) Inventors: Ruiming ZHENG, Beijing (CN); Yuwei REN, Beijing (CN); Chenxi HAO, Beijing (CN); Jiming GUO, Beijing (CN)

(21) Appl. No.: 18/872,742

(22) PCT Filed: Jul. 21, 2022
(86) PCT No.: PCT/CN2022/107041

§ 371 Date: Dec. 6, 2024

(51) Int. Cl. H04W 76/28; H04L 41/16; H04W 24/08

(52) U.S. Cl. CPC H04W 76/28; H04L 41/16; H04W 24/08

(57) ABSTRACT

Disclosed are systems and techniques for wireless communications. For instance, a technique can include receiving information associated with one or more network data packets, predicting, based at least in part on the received information, when a next network data packet is to be received, determining a discontinuous reception (DRX) configuration based on the prediction of when the next network data packet is to be received, and outputting an indication of the DRX configuration for transmission to a device.

### CROSS-REFERENCE TO RELATED APPLICATIONS

This application for patent is a 371 of international Patent Application PCT/CN2022/107041, filed Jul. 21, 2022, which is hereby incorporated by referenced in its entirety and for all purposes.

### FIELD

The present disclosure generally relates to wireless communications. For example, aspects of the present disclosure relate to systems and techniques for artificial intelligence (AI) based discontinuous reception (DRX) configuration.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. For example, a discontinuous reception (DRX) mode may include an active state (where a terminal monitors a downlink channel to receive corresponding data and transmits uplink data) and a sleep state (where the terminal no longer monitors the downlink channel), which can allow the terminal to save energy. In some cases, a DRX configuration may have a fixed or pre-determined pattern, where DRX cycles are periodically provided in the fixed or pre-determined pattern. However, a DRX configuration with a fixed/pre-determined pattern may not be able to adapt to non-periodic data traffic scenarios or different periodic data traffic profiles. For instance, using a fixed or pre-determined DRX configuration pattern may result in relatively large data transmission delays and difficulty in maximizing energy efficiency.

Systems and techniques are described herein for providing an artificial intelligence (AI)-based DRX configuration that can dynamically adjust DRX configurations based on a prediction generated using an AI system. For instance, according to various aspects described herein, the systems and techniques may include DRX predication in an AI-based DRX configuration, AI-based short DRX/long DRX cycle switching, AI-based DRX inactivity timer (e.g., denoted as drx-Inactivity Timer) prediction, switching between AI-DRX and legacy DRX modes (e.g., DRX mode without using AI), or any combination thereof.

In one illustrative example, an apparatus for wireless communications is provided that includes at least one memory and at least one processor (e.g., implemented in circuitry) coupled to the at least one memory and configured to: receive information associated with one or more network data packets; predict, based at least in part on the received information, when a next network data packet is to be received; determine a discontinuous reception (DRX) configuration based on the prediction of when the next network data packet is to be received; and output an indication of the DRX configuration for transmission to a device.

In another illustrative example, a method for wireless communications by a wireless device is provided. The method includes: receiving information associated with one or more network data packets; predicting, based at least in part on the received information, when a next network data packet is to be received; determining a discontinuous reception (DRX) configuration based on the prediction of when the next network data packet is to be received; and outputting an indication of the DRX configuration for transmission to a device.

In another illustrative example, a non-transitory computer-readable storage medium comprising instructions stored thereon which, when executed by at least one processor, causes the at least one processor to: receive information associated with one or more network data packets; predict, based at least in part on the received information, when a next network data packet is to be received; determine a discontinuous reception (DRX) configuration based on the prediction of when the next network data packet is to be received; and output an indication of the DRX configuration for transmission to a device.

In another illustrative example, an apparatus for wireless communications is provided. The apparatus includes: means for receiving information associated with one or more network data packets; means for predicting, based at least in part on the received information, when a next network data packet is to be received; means for determining a discontinuous reception (DRX) configuration based on the prediction of when the next network data packet is to be received; and means for outputting an indication of the DRX configuration for transmission to a device.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIGS. 5A-5D depict various example aspects of data structures for a wireless communication system, in accordance with aspects of the present disclosure;

FIG. 6 illustrates an example architecture of a neural network, in accordance with some aspects of the present disclosure;

FIG. 7 is a subframe diagram illustrating example DRX cycles 700, in accordance with aspects of the present disclosure;

FIG. 8 illustrates DRX cycles, in accordance with aspects of the present disclosure;

FIG. 9 is a block diagram illustrating an ML engine, in accordance with aspects of the present disclosure;

FIG. 10 is a block diagram illustrating a system for AI-based DRX signaling, in accordance with aspects of the present disclosure;

FIG. 11 illustrates elements for a DRX configuration object, in accordance with aspects of the present disclosure;

FIG. 12A is block diagram illustrating a high capability ML engine, in accordance with aspects of the present disclosure;

FIG. 12B is a block diagram illustrating a low capability ML engine, in accordance with aspects of the present disclosure;

FIG. 12C is a block diagram illustrating a plurality of long short term memory models (LSTMs) outputting a predicted DRX timer based on traffic data and other historical information;

FIG. 13 illustrates UE DRX cycles based on a StopShortCycleTimer DRX configuration, in accordance with aspects of the present disclosure;

FIG. 14 illustrates UE DRX cycles based on a DisableShortCycleTimer DRX configuration, in accordance with aspects of the present disclosure;

FIGS. 15A and 15B illustrate UE DRX cycles based on a drx-Inactivity Timer DRX configurations, in accordance with aspects of the present disclosure;

FIG. 16A is a block diagram illustrating a UE including a ML engine, in accordance with aspects of the present disclosure;

FIG. 16B illustrates UE drx-InactivityTimer early termination, in accordance with aspects of the present disclosure;

FIG. 17A illustrates switching between AI-based DRX configuration and legacy DRX configurations, in accordance with aspect of the present disclosure;

FIG. 17B is a flow diagram illustrating a technique for switching between AI-based DRX configuration and legacy DRX configuration, in accordance with aspects of the present disclosure;

FIG. 18 is a flow diagram illustrating a process for AI-based DRX configuration, in accordance with aspects of the present disclosure; and

FIG. 19 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Various techniques are provided in accordance with wireless technologies (e.g., The 3rd Generation Partnership Project (3GPP) 5G/New Radio (NR) Standard) to provide terminal energy savings. One example of such a technique is discontinuous reception (DRX). In some cases, DRX may include an active state (e.g., on duration) and a sleep state (e.g., off sleep). In the active state, a user equipment (UE) or terminal monitors a downlink channel (e.g., a Physical Downlink Control Channel (PDCCH)) and receives corresponding data (e.g., on a Physical Downlink Shared Channel (PDSCH)). In the sleep state, the UE or terminal closes a receiving unit and no longer monitors the downlink channel (e.g., the PDCCH), so as to achieve energy savings.

In a DRX active state, a UE may monitor and detect incoming packets. Once an inactivity timer expires, the UE may switch to the sleep mode. After the sleep mode, the UE may check the PDCCH and switch back to the active state. In some cases, if there are no packets in a number of consecutive short DRX cycles, the UE may switch to a long DRX cycle.

A DRX configuration with a pre-determined (or fixed) pattern may not be able to adapt to non-periodic data traffic scenarios or different periodic data traffic profiles. In some cases (e.g., particular services), it may be better to utilize different DRX cycles that can be configured to adapt different traffic patterns. In some cases, upstream and downstream data are not generated periodically and DRX with a pre-determined period cannot meet the requirements of the UE data reception. This may result in relatively large data transmission delays and difficulty in maximizing energy efficiency.

Systems, apparatuses, electronic devices, methods (also referred to as processes), and computer-readable media (collectively referred to herein as “systems and techniques”) are described herein for providing an artificial intelligence (AI)-based DRX configuration. The AI-based DRX configuration can dynamically adjust UE DRX configurations based on a prediction generated by an AI system. Aspects of dynamically adjusting UE DRX configurations may include DRX predication in AI-based DRX configuration, AI-based switching between short and long DRX cycles, AI-based DRX inactivity timer (e.g., denoted as drx-InactivityTimer) prediction, switching between AI-DRX and legacy DRX modes (e.g., DRX mode without using AI), or any combination thereof.

Additional aspects of the present disclosure are described in more detail below.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

In some aspects, wireless communications networks may be implemented using one or more modulation schemes. For example, a wireless communication network may be implemented using a quadrature amplitude modulation (QAM) scheme such as 16QAM, 32QAM, 64QAM, etc.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

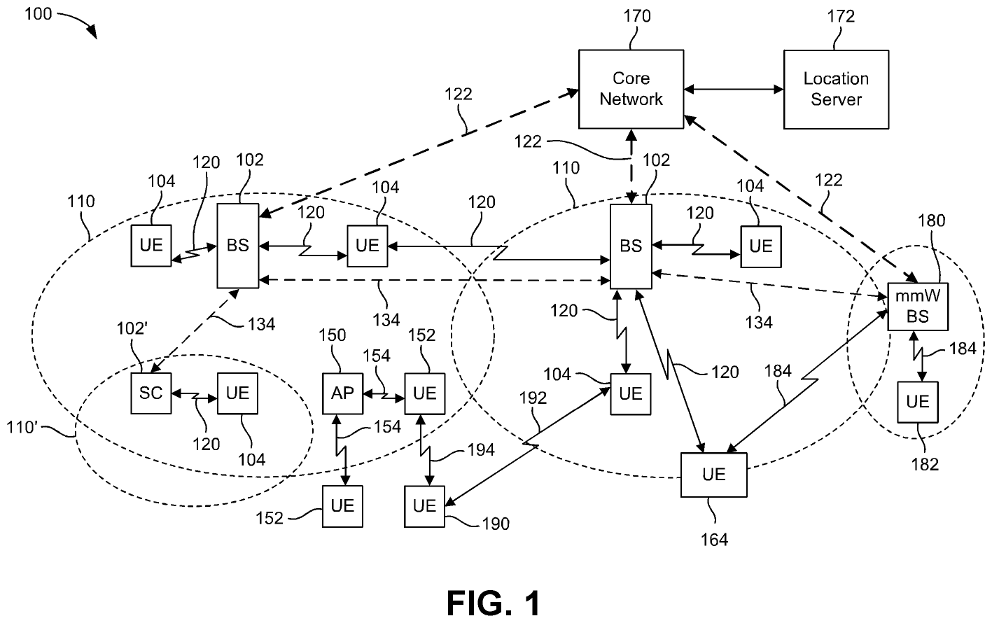

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

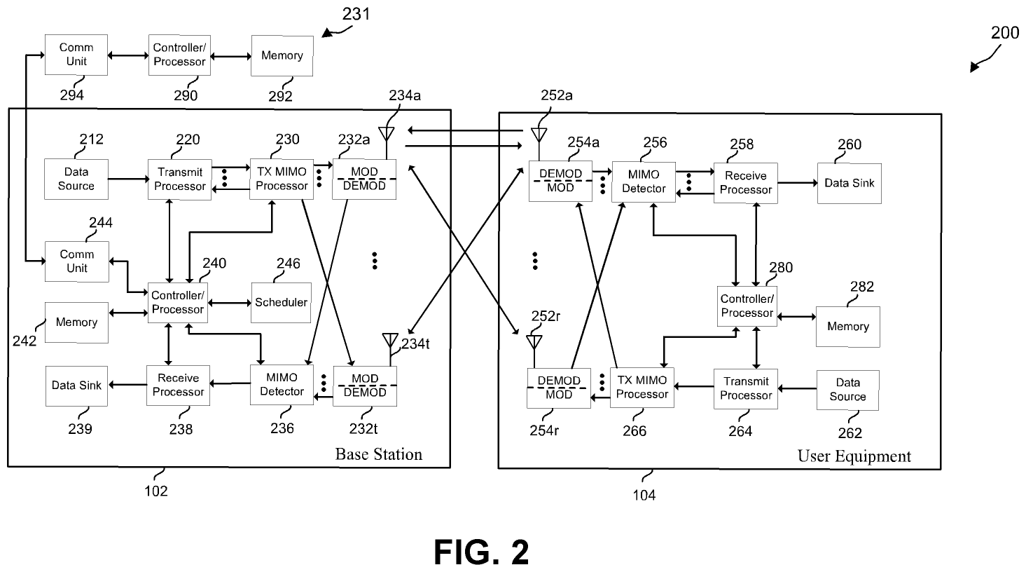

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

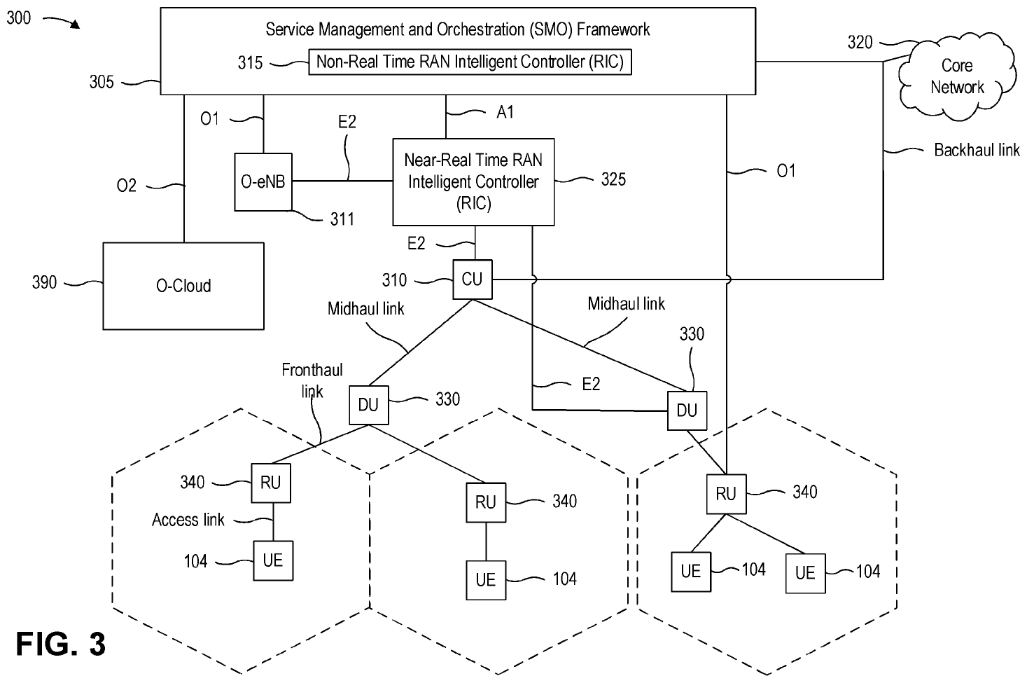

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUS 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

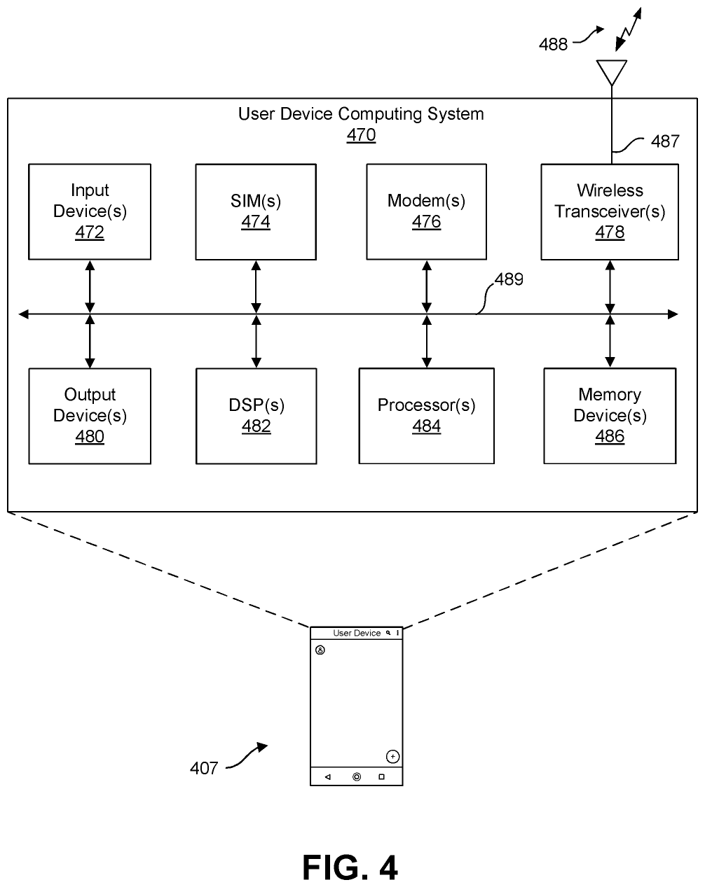

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

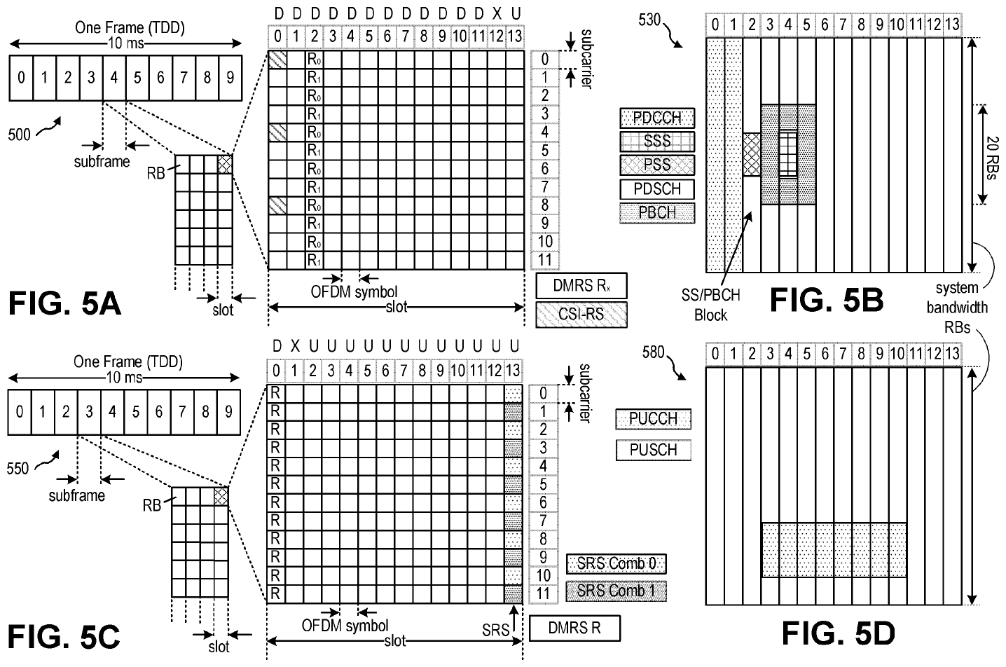

FIGS. 5A-5D depict various example aspects of data structures for a wireless communication system, such as wireless communication system 100 of FIG. 1. FIGS. 5A-5D depict aspects of data structures for a wireless communication network, such as wireless communication network 100 of FIG. 1. In particular, FIG. 5A is a diagram 500 illustrating an example of a first subframe within a 5G (e.g., 5G NR) frame structure, FIG. 5B is a diagram 530 illustrating an example of DL channels within a 5G subframe, FIG. 5C is a diagram 550 illustrating an example of a second subframe within a 5G frame structure, and FIG. 5D is a diagram 580 illustrating an example of UL channels within a 5G subframe.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 5A and 5C, the 5G frame structure is assumed to be TDD, with subframe 4 being configured with slot format 28 (with mostly DL), where Dis DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 5A-5D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 5A, some of the REs carry reference (pilot) signals (RS) for a UE (e.g., UE 104, UE 152, UE 190). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 5B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., UE 104, UE 152, UE 190) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 5C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 5D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

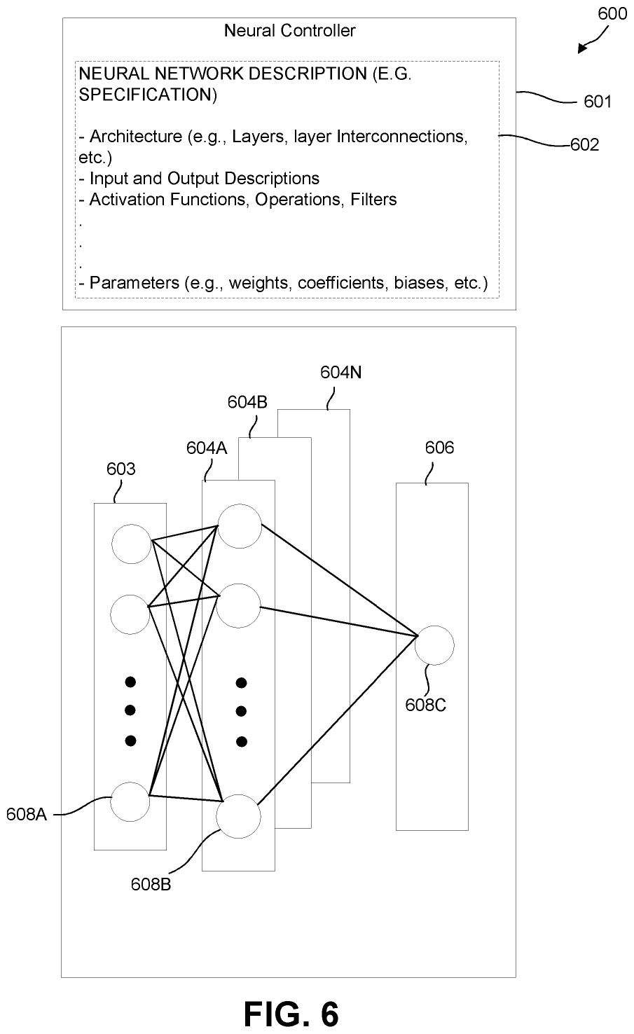

FIG. 6 illustrates an example architecture of a neural network 600 that may be used in accordance with some aspects of the present disclosure. The example architecture of the neural network 600 may be defined by an example neural network description 602 in neural controller 601. The neural network 600 is an example of a machine learning model that can be deployed and implemented at the base station 102, the central unit (CU) 310, the distributed unit (DU) 330, the radio unit (RU) 340, and/or the UE 104. The neural network 600 can be a feedforward neural network or any other known or to-be-developed neural network or machine learning model.

The neural network description 602 can include a full specification of the neural network 600, including the neural architecture shown in FIG. 6. For example, the neural network description 602 can include a description or specification of architecture of the neural network 600 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 600 can reflect the neural architecture defined in the neural network description 602. The neural network 600 can include any suitable neural or deep learning type of network. In some cases, the neural network 600 can include a feed-forward neural network. In other cases, the neural network 600 can include a recurrent neural network, which can have loops that allow information to be carried across nodes while reading in input. The neural network 600 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 600 can represent any other neural or deep learning network, such as an autoencoder, a deep belief nets (DBNs), a recurrent neural network (RNN), etc.

In the non-limiting example of FIG. 6, the neural network 600 includes an input layer 603, which can receive one or more sets of input data. The input data can be any type of data (e.g., image data, video data, network parameter data, user data, etc.). The neural network 600 can include hidden layers 604A through 604N (collectively “604” hereinafter). The hidden layers 604 can include n number of hidden layers, where n is an integer greater than or equal to one. The n number of hidden layers can include as many layers as needed for a desired processing outcome and/or rendering intent. In one illustrative example, any one of the hidden layers 604 can include data representing one or more of the data provided at the input layer 603. The neural network 600 further includes an output layer 606 that provides an output resulting from the processing performed by hidden layers 604. The output layer 606 can provide output data based on the input data.

In the example of FIG. 6, the neural network 600 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 603 can activate a set of nodes in the first hidden layer 604A. For example, as shown, each input node of the input layer 603 is connected to each node of the first hidden layer 604A. The nodes of the hidden layer 604A can transform the information of each input node by applying activation functions to the information. The information derived from the transformation can then be passed to and can activate the nodes of the next hidden layer (e.g., 604B), which can perform their own designated functions. Example functions include convolutional, up-sampling, data transformation, pooling, and/or any other suitable functions. The output of hidden layer (e.g., 604B) can then activate nodes of the next hidden layer (e.g., 604N), and so on. The output of last hidden layer can activate one or more nodes of the output layer 606, at which point an output can be provided. In some cases, while nodes (e.g., nodes 608A, 608B, 608C) in the neural network 600 are shown as having multiple output lines, a node can have a single output and all lines shown as being output from a node can represent the same output value.

In some cases, each node or interconnection between nodes can have a weight that is a set of parameters derived from training the neural network 600. For example, an interconnection between nodes can represent a piece of information learned about the interconnected nodes. The interconnection can have a numeric weight that can be tuned (e.g., based on a training dataset), allowing the neural network 600 to be adaptive to inputs and able to learn as more data is processed.

The neural network 600 can be pre-trained to process the features from the data in the input layer 603 using different hidden layers 604 in order to provide the output through the output layer 606. For example, in some cases, the neural network 600 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

According to aspects of the present disclosure, 5G introduces certain technologies for terminal energy saving such as discontinuous reception (DRX). In some cases, DRX may include two states: an active state (e.g., on duration) and a sleep state (e.g., off sleep). In the active state, the terminal monitors the downlink channel such as PDCCH and receives the corresponding data. In the sleep state, the terminal closes the receiving unit and no longer monitors the downlink channel such as PDCCH, so as to achieve the purpose of energy saving.

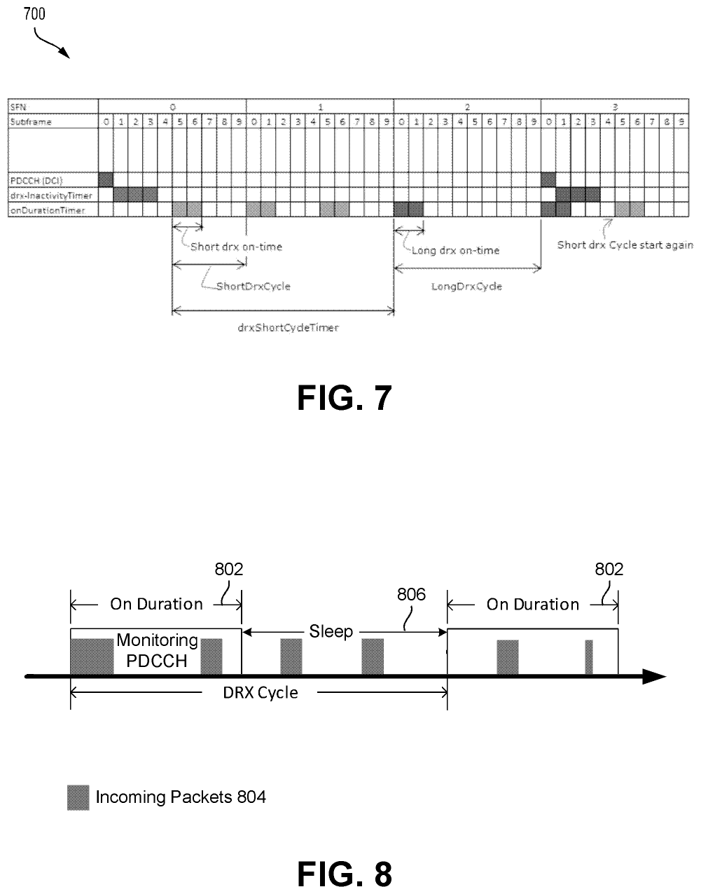

FIG. 7 is a subframe diagram illustrating example DRX cycles 700, in accordance with aspects of the present disclosure. In some cases, DRX may provide two levels of monitoring granularity via a short and long DRX, as shown in FIG. 7. The levels of monitoring granularity allow devices, such as UEs, to only monitor scheduling messages during well-defined monitoring intervals e.g., during 10 ms on-durations once every 160 ms in long DRX. The rest of the time the device can remain in sleep mode.

In some implementations, a DRX inactivity timer may be used. Upon detecting a control channel grant during the DRX ON period, the UE may stay active for the duration of the configured inactivity timer in order to continue monitoring the control channel for possible following grants of further incoming and/or buffered traffic payload at the gNB.

In a DRX active state, a UE may monitor and detect incoming packets. When the UE is out of the inactivity timer, UE switches into the sleep mode. After the sleep mode, the UE checks the PDCCH and switches back to the active state. In some cases, if there are no packets in a number of consecutive short DRX cycle, the UE may switch to the long DRX cycle.

A DRX configuration with a pre-determined (or fixed) pattern may not be able to adapt to non-periodic data traffic scenarios or different periodic data traffic profiles. For different services, it may be better that different DRX cycles can be configured to adapt the traffic pattern. In some cases, upstream and downstream data are not generated periodically and DRX with a pre-determined or fixed period cannot meet the requirements of terminal (e.g., UE) data reception. This may result in relatively large data transmission delays and difficulty in maximizing energy efficiency.

DRX uses fixed length short and long sleep cycles to reduce the power consumption of UE. However, 5G and future networks are expected to deal with different types of services and these services may have different size of packet lengths, variable packet arrival time and variable transmission time interval (TTI). Fixed length DRX cycle mechanism may not be suitable for such services as the fixed DRX cycles may under-utilize or over-utilize TTI.

As shown in FIG. 8, a fixed length DRX on durations 802 cannot match the dynamic packets pattern of incoming packets 804. The DRX may not be able to effectively set the sleep state 806 to ensure the low-power consumption and short latency. In some cases, the fixed DRX durations may result in additional latency when incoming packets 804 arrive while the UE is configured in the sleep state 806. In such cases, the UE may not be able to wake up to receive the packets in time. The network then may have to store incoming packets 804, such as in a gNB buffer or core network (CN) buffer and wait for UE wake up to monitor PDCCH in the next DRX on duration 802.

In some cases, artificial intelligence (AI) has shown potential to address non-linear problems, e.g., predicting stock price or auto driving. AI (e.g., machine learning (ML)) based solutions may include multiple types of algorithms, such as convolutional neural networks (CNN), long short term memory models (LSTM), transformer neural networks, reinforcement learning, etc. As an example, channel estimation problems in RANI could be formulated as denoising work, e.g., based on the U-Net with CNN operations. For DRX, DRX performance is associated with packet distribution in a time series, so a sequence related AI technique could be useful.

Recurrent Neural Network (RNN) are a type of AI which may be used to learn long-term dependencies of a sequence for predicting the upcoming value of a sequence. The term long-term dependency refers to a sequence, whose desired/current output values (prediction results) depend on long-sequence of previous input values rather than only a previous input value. An AI's ability to extract the time-domain information may be helpful to analyze the distribution of packets, which follow some trends and rules, but may be hard to analyze based on traditional techniques.

In accordance with aspects of the present disclosure, an AI based DRX configuration which can dynamically adjust UE DRX configurations based on the AI prediction. Aspects of dynamically adjusting UE DRX configurations may include DRX predication in AI-based DRX configuration, AI-based short/long DRX cycle switching, AI-based drx-Inactivity Timer prediction, and switching between AI-DRX and legacy DRX mode (e.g., without AI).

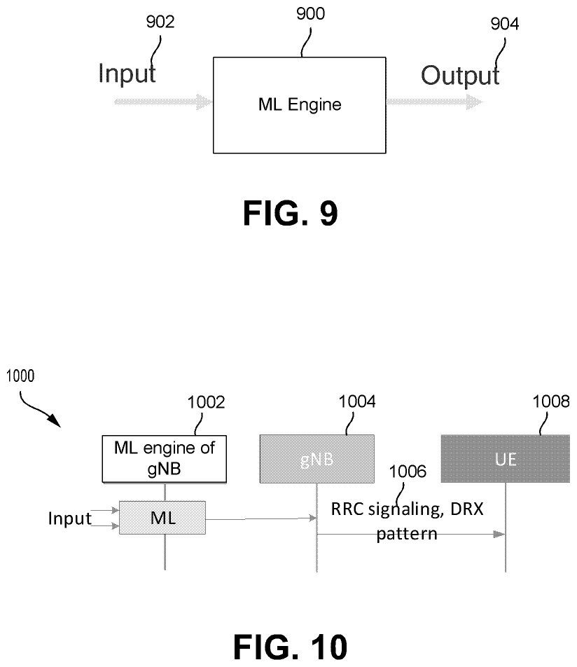

FIG. 9 is a block diagram illustrating an ML engine 900, in accordance with aspects of the present disclosure. As an example, one or more devices in a wireless system may include ML engine 900. In this example, ML engine 900 includes three parts, input 902 to the ML engine 900, the ML engine, and the output 904 from the ML engine 900. In some cases, the input 902 may be the latest (e.g., current) packet information as well as previous historical packet information. The information may include average latency, packet arrival time, packet length, and/or packet size. The output 904 of the ML engine 900 may be a predicted time of the next packet and/or optimized DRX parameters. In some cases, the ML model may use different training options. For example, the ML model may be trained using supervised learning, such as for an RNN/LSTM model. As another example, the ML model may be trained using non-supervised learning, such as using reinforcement learning.

In a traditional (e.g., without AI) DRX, in order to synchronize UE wake up timing with network scheduling timing, the network decides when to let UE sleep and when to wake up, using an RRC message to inform the UE of timings. Thus, the network controls the DRX procedure and UE follows the configured pattern to wake up.

FIG. 10 is a block diagram illustrating a system for AI-based DRX signaling 1000, in accordance with aspects of the present disclosure. For an AI-based DRX system 1000, the ML engine 1002 (e.g., ML engine 900) may be defined at the network side. For example, the ML engine 1002 may be located within, or part of, an gNB 1004 (or other base station, such as base station 102 of FIG. 1). The overall signaling may be such that the ML engine 1002 may, based on the latest and historical information, predict an optimum DRX configuration. This DRX configuration may be signaled, such as via RRC signaling 1006, to the UE 1008 when the UE 1008 is in an active time (e.g., DRX on duration). In this example, the gNB 1004 determines the dynamic sleep DRX pattern and configures it to the UE 1008. In some cases, the ML engine 1002 may define a DRX on a per data radio bearer (DRB) basis. Thus, for each DRB, the ML engine 1002 may generate a prediction output.

In some cases, the ML engine (e.g., ML engine 900) may predict DRX cycle values based on a pattern of arrived packets (e.g., for historical or previous arrived packets). For example, considering one periodical downlink (DL) packets pattern, the ML engine may predict a new DRX cycle value for the DRX short cycle. Such DRX short cycle can be used to optimizes a tradeoff between latency and power consumption.

One scenario is that the coming packet can perfectly match the short DRX cycle. Within the legacy DRX procedure, the short DRX cycle is fixed or pre-determined, which cannot match the packet pattern. In some cases, the UE always wake up in the DRX-on duration, even if there are not any packets in a long time. Such frequent wake-up may be inefficient. In some cases, based on predictions from the ML engine, the UE may not need to wake up as frequently, and still receive incoming packets in time. This would be a good trade-off between the power consumption and latency.

In some cases, based on ML engine predictions, new DRX parameter values may be configured for the AI-based DRX. The predicated values may include one or more of a new DRX ON duration, new short DRX cycle, new long DRX cycle, new DRX inactivity timer, new drx-ShortCycleTimer, and/or new drxStartOffset. In some cases, where a value is not predicted by the ML engine, a legacy, non-ML value based DRX parameter values may be reused.

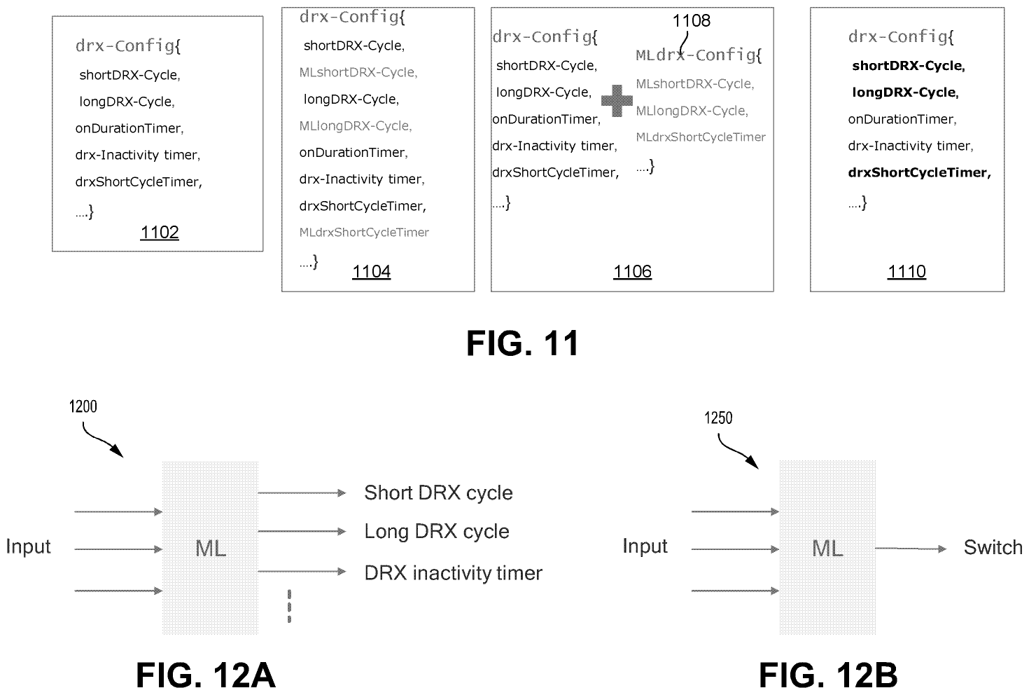

FIG. 11 illustrates elements for a DRX configuration object, in accordance with aspects of the present disclosure. In some cases, there may be several options for AI-based DRX configuration using RRC signaling. In FIG. 11, box 1102 illustrates example elements for a current DRX configuration object. As a first option 1104 for elements for a DRX configuration object, in the DRX configuration, new elements for AI-based prediction values may be added. These elements may include at least MLshortDRX-Cycle, MLlongDRX-Cycle, and MLdrxShortCycleTimer. In a second option 1106, in addition to the existing DRX configuration object, an additional DRX configuration object, shown here as configuration object MLdrx-Config 1108, may be added to RRC signaling to configure new values based on the AI based predictions. As a third option 1110, the legacy values may be replaced with AI-based predicted values in the DRX configuration object.

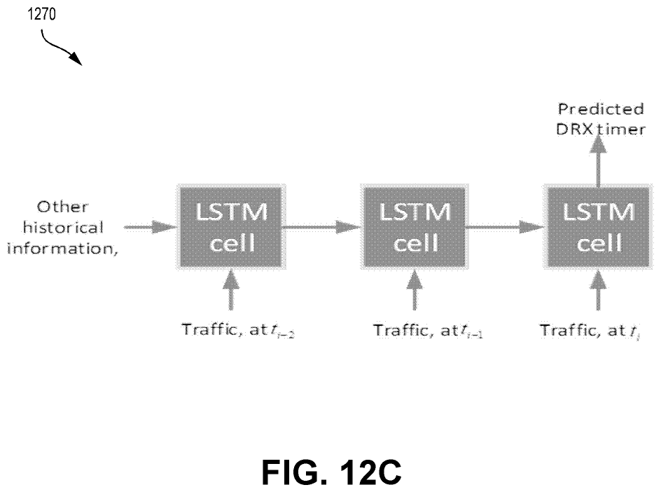

FIG. 12A is block diagram illustrating a high capability ML engine 1200, in accordance with aspects of the present disclosure. In some cases, AI-based short/long DRX cycle switching may be performed according to a network traffic pattern or history information. In some cases, a high capability ML engine 1200 may predict values of one or more DRX parameters. For example, a high capability ML engine 1200 may predict the value of DRX parameters, such as DRX ON duration, length of short DRX cycle, length of a long DRX cycle, etc. The more accurate DRX value prediction may use a higher capability ML model, which could lead to an increased ML complexity.

FIG. 12B is a block diagram illustrating a low capability ML engine 1250, in accordance with aspects of the present disclosure. In some cases, the low capability ML engine 1250 may predict whether and when switch between the short and long DRX cycles instead of predicting actual values of DRX parameters, such as DRX ON duration, length of DRX cycle, etc. By predicting whether and when switch between the short and long DRX cycle rather than actual values of DRX parameters, ML model complexity may be reduced to help simplify implementation and reduce costs. In some cases, the low capability ML engine 1250 may control the drx-ShortCycleTimer. The status and length of drx-ShortCycleTimer could be optimized by the low capability ML engine 1250. In such cases, the low capability ML engine 1250 may provide an indication whether UE should switch between short and long DRX cycles.

FIG. 12C is a block diagram 1270 illustrating a plurality of long short term memory models (LSTMs) outputting a predicted DRX timer based on traffic data and other historical information.

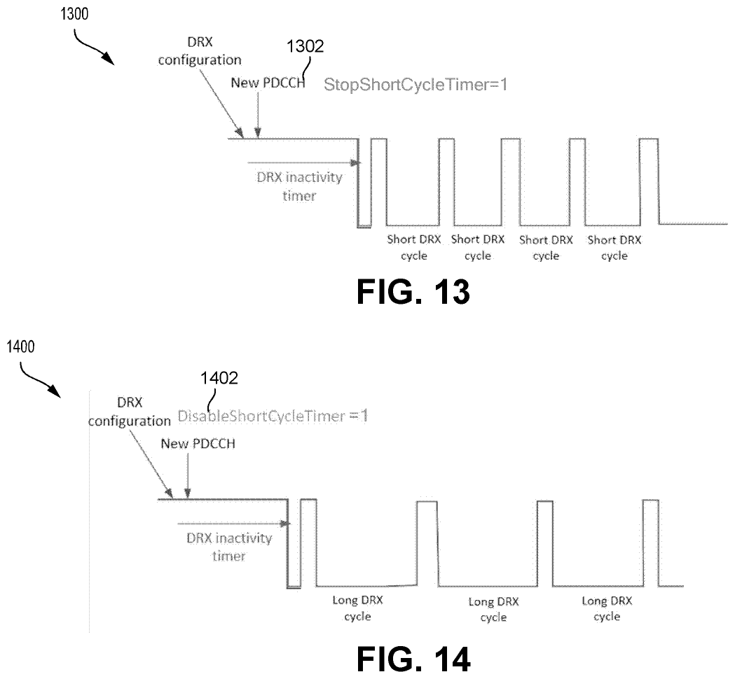

FIG. 13 illustrates UE DRX cycles based on a StopShortCycleTimer DRX configuration 1300, in accordance with aspects of the present disclosure. In some cases, based on the predication of the DRX cycle, the network sends an indication to the UE to stop the drx-ShortCycle Timer 1302, for example, by setting StopShortCycleTimer=1. In some cases, this indication may be received via a PDCCH message. The UE may then stay at short DRX cycle. When receiving the indication, UE would not count the time, and the timer will not expire. If so, the short DRX cycle would be repeated until UE receives the indication to fallback the drx-ShortCycleTimer setting. This indication may be derived from the ML engine, such as low capability ML engine 1250 or high capability ML engine 1200.

In some cases, the configuration (e.g., the indication to the UE to stop the drx-ShortCycleTimer 1302) could be based on two options. The first option is that the indication could be configured in the MAC CE or DCI. A bit may be added to the MAC CE or DCI to indicate the StopShortCycleTimer=1. In a following DRX procedure (after completion of the current DRX inactivity timer), UE would not enter into the long DRX cycle. The second option is that the indication could be configured based on the RRC signaling, as one element in the DRX configuration, e.g., StopShortCycleTimer=1. When receiving the DRX re-configuration, UE knows there is no long DRX sleep cycle configured.

FIG. 14 illustrates UE DRX cycles based on a DisableShortCycleTimer DRX configuration 1400, in accordance with aspects of the present disclosure. In some cases, based on the predication of the DRX cycle, the network sends an indication to the UE to disable the drx-ShortCycleTimer 1402, for example, by setting DisableShortCycleTimer=1. The UE may then go to the long DRX cycle in the next round DRX cycle without waiting for the expiration of the drx-ShortCycleTimer. This indication may be derived from the ML engine, such as low capability ML engine 1250 or high capability ML engine 1200.

In some cases, the configuration (e.g., the indication to the UE to disable the drx-ShortCycleTimer 1302) could be based on two options. The first option is that the indication could be configured in the MAC CE or DCI, and there is 1 bit added to indicate the DisableShortCycleTimer=1. When receiving the indication, the short DRX cycle is disabled. The second option is that the indication could be configured based on the RRC signaling, as one element in the DRX configuration, e.g., DisableShortCycleTimer.

In some cases, the ML engine, such as high capability ML engine 1200, may predict the length of the drx-InactivityTimer. According to the predicated value, network transmit an indication to the UE to early terminate the drx-Inactivity Timer. For example, the ML engine may predict that there will be no more data for the UE coming during a remaining drx-Inactivity Timer duration. The network may indicate the UE, such as via a PDCCH message, to terminate the timer (e.g., drx-Inactivity Timer) early, and switch to the sleep mode in order to save UE power. In some cases, the ML engine may predict the longer drx-Inactivity Timer than the default setting. In such cases, the network may transmit an indication to the UE to extend (e.g., reconfigure) and/or reset drx-Inactivity Timer to enable a longer drx-Inactivity Timer.

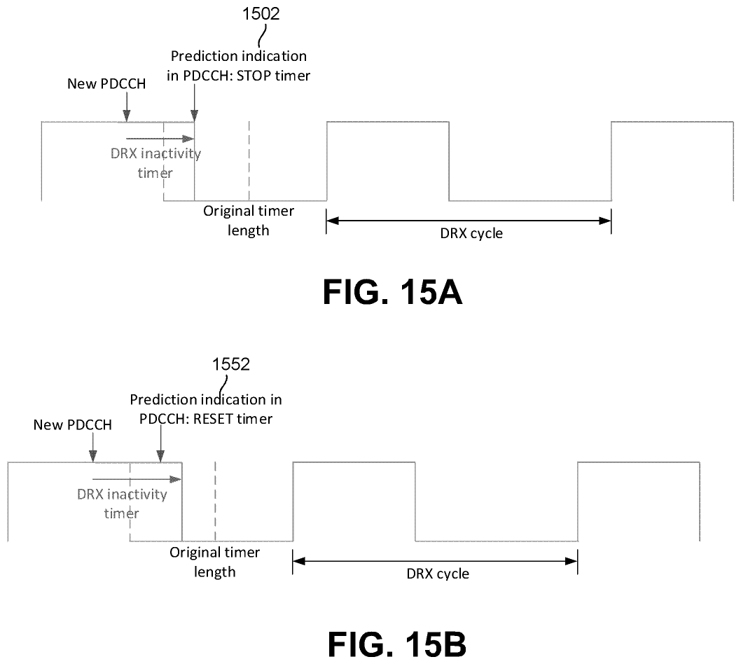

FIGS. 15A and 15B illustrate UE DRX cycles based on a drx-Inactivity Timer DRX configurations, in accordance with aspects of the present disclosure. In some cases, the configuration (e.g., the indication to the UE of drx-Inactivity Timer value) could be based on two options. In a first option, shown in FIG. 15A, the ML engine, such as high capability ML engine 1200, may predict the length of the drx-Inactivity Timer and the network may indicate to the UE to stop drx-Inactivity Timer 1502. When UE receives the indication, the timer would not count, and UE would enter into the sleep mode directly. In a second option, shown in FIG. 15B, the ML engine, such as high capability ML engine 1200, may predict the length of the drx-Inactivity Timer and the network may indicate UE to reset 1552 the drx-Inactivity Timer or to re-configure a smaller (or larger) value for drx-InactivityTimer. When UE receives the indication, UE could restart tithe DRX inactivity timer with the new value.

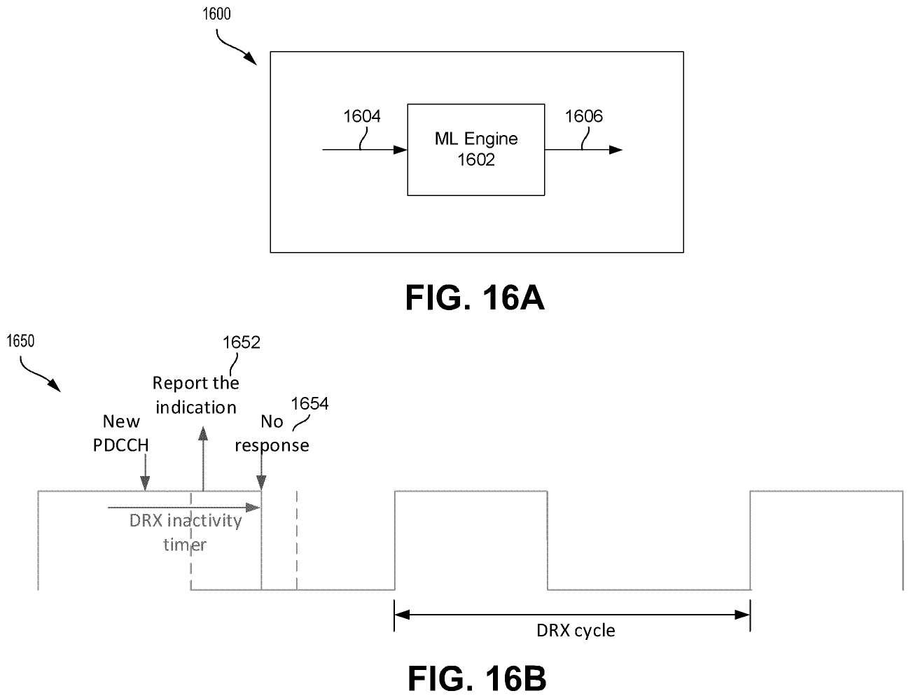

FIG. 16A is a block diagram illustrating a UE 1600 including a ML engine 1602, in accordance with aspects of the present disclosure. In some cases, the ML engine 1602 may be similar to ML engine 900 of FIG. 9. In some cases, the ML engine 1602 may receive, as input 1604, current packet information and/or historical packet information and output 1606 predictions regarding a length of the drx-Inactivity Timer for the UE 1600. In some cases, the ML engine 1602 may also receive, for example as input 1604, information associated with one or more programs executing on the UE to predict the length of the drx-Inactivity Timer.

FIG. 16B illustrates UE drx-InactivityTimer early termination 1650, in accordance with aspects of the present disclosure. In some cases, if the UE, such as UE 1600, has the capability to use an ML engine, such as ML engine 1602, to predict the length of the drx-Inactivity Timer. In some cases, after the drx-Inactivity Timer starts, the UE 1600 may send an indication of early drx-Inactivity Timer termination 1652 to the network, for example via layer 1 or layer 2 signaling such as via a medium access control (MAC) control element (MAC CE), before the drx-InactivityTimer expires indicating that the UE 1600 may stop the drx-Inactivity Timer early. In some cases, the UE 1600 may indicate a time at which the UE 1600 intends to stop the drx-Inactivity Timer. If network does not provide a response 1654 to the indication that the UE 1600, for example in a PDCCH opportunity after the indication of early drx-Inactivity Timer termination 1652, but before the termination of the drx-InactivityTimer, may stop the drx-Inactivity Timer early in one or more following PDCCH occasions, and the UE 1600 may enter a sleep mode. If the network does provide a response, the UE 1600 may follow the configuration in the response. If the UE 1600 reported indication of early drx-Inactivity Timer termination is not permitted by the network, the network may send a response in one or more following PDCCH occasions indicating to the UE 1600 that should not stop the drx-InactivityTimer early. In some cases, the length of drx-Inactivity Timer may be predicted from the history of the actual length of drx-Inactivity Timer.

Alternatively, after the UE 1600 sends an indication of early drx-Inactivity Timer termination 1652 to the network, if the network does not provide a response to the indication of early drx-Inactivity Timer termination 1652, the UE 1600 may follow the current DRX configuration. If the UE 1600 receives a response from the network, then the UE 1600 may follow the DRX configuration (which may include early drx-InactivityTimer termination) or other instructions indicated in the response.

In some cases, the ML engine 1602 of UE 1600 may predict that the length of the drx-Inactivity Timer should be extended. In such cases, the UE 1600 may transmit an indication that the UE 1600 may extend (or intends to extend) the drx-Inactivity Timer. For example, the UE may indicate to the network (e.g., to a base station, such as a gNB, or to a portion of the base station, such as a CU, DU, RU, Near-RT RIC, Non-RT RIC, etc.) a time at which the UE 1600 intends to stop (or reset) the drx-InactivityTimer, which may be after the configured (e.g., configured by the network) end of the drx-InactivityTimer. If the UE 1600 does not receive a response from the network, the UE 1600 may proceed to extend the drx-Inactivity Timer. If the UE 1600 receives a response from the network, then the UE 1600 may follow the DRX configuration (which may include extending the drx-InactivityTimer termination) or other instructions indicated in the response.

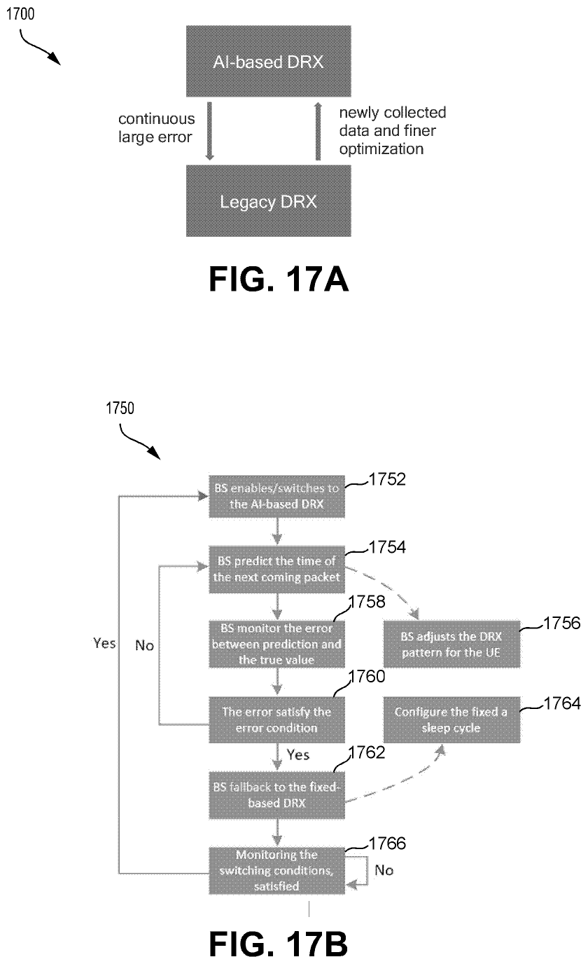

In some cases, it may be useful to switch between AI-based DRX configuration and legacy DRX configuration as shown in FIG. 17A. For example, the AI-based DRX configuration via a ML engine may not be suitable for a particular network traffic pattern. In such cases, the network may fallback to legacy DRX configuration and switch back to AI-based DRX configuration after the model is further optimized based on the newly collected data.

FIG. 17B is a flow diagram illustrating a technique for switching between AI-based DRX configuration and legacy DRX configuration 1750, in accordance with aspects of the present disclosure. At step 1752, a BS may enable (e.g., switch to) an AI-based DRX configuration technique. At step 1754, the BS may predict a time for a next incoming network packet. In some cases, at step 1756, the BS may adjust a DRX pattern (e.g., configuration) for a UE, for example, by sending DRX configuration object, such as those discussed in FIG. 11, to the UE. At step 1758, the BS may monitor error as between the predicted DRX configuration and actually received network packets.

In some cases, the BS may monitor error between the predicted DRX configuration and actually received network packets based on two options. A first option may be based on a mean latency of the scheduling packets. In the first option, there may be a predefined threshold τ. If the loss |Pᵢ-Tᵢ| is continuously larger than the threshold τᵢ where Pᵢ is the actual scheduled timestamp and Tᵢ is the real arrived timestamp, the error of the ML-based configuration may be determined to satisfy the error condition at step 1760. A second option may monitor whether there are no data transmissions to the UE during the active time in the predicted DRX ON duration or while the drx-Inactivity Timer is running. If there are no data transmissions to the UE during the predicted DRX ON duration or while the drx-Inactivity Timer is running then the error of the ML-based configuration may be determined to satisfy the error condition at step 1760.

If the error of the ML-based configuration satisfies the error condition, the system may fall back to the legacy DRX configuration at step 1762 and configure the UE (e.g., transmit a DRX configuration to the UE) with a legacy, fixed, default, or pre-configured DRX configuration at step 1764. If the error of the ML-based configuration does not satisfy the error condition at step 1760, execution may return to step 1754.

At step 1766, the BS may monitor switch conditions to determine whether to switch from the legacy DRX configuration to the AI-based DRX configuration technique. In some cases, if the ML engine is optimized based on online adaptation, the AI-based DRX is triggered. For example, the BS may continue to monitor error between the predicted DRX configuration and actually received network packets and switch back to the AI-based DRX configuration if the error drops below the error condition. In some cases, if the actual packet pattern of the network matches an expected pattern, e.g., a periodical pattern, the BS may switch to the AI-based DRX configuration. As an example, a gaming application may have a specific network traffic characteristic, such as packet size and/or time domain traffic pattern. This network traffic characteristic may be learned, for example via training, by the ML engine such that the ML engine may identify occurrences of network traffic characteristic and make predictions for expected network traffic, as well as handle variations of the network traffic characteristic. Based on these predictions, the DRX configuration of the UE may be adjusted.

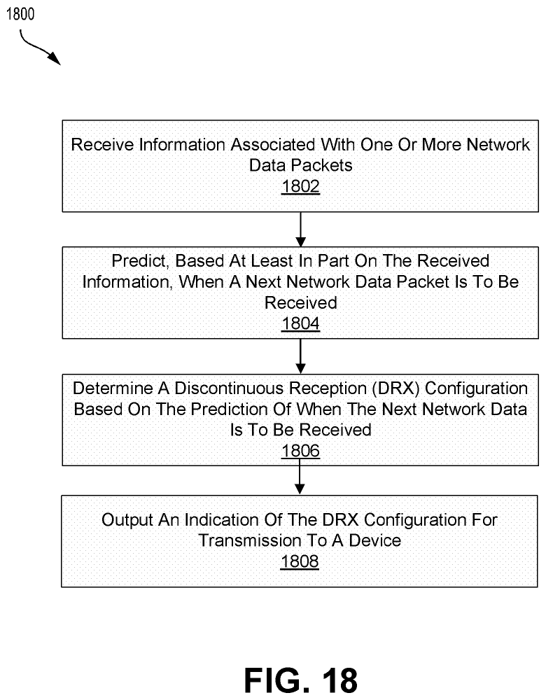

FIG. 18 is a flow diagram of a process for wireless communications 1800 by a wireless device, in accordance with aspects of the present disclosure. At operation 1802, process 1800 can include receiving information associated with one or more network data packets. At operation 1804, process 1800 can include predicting, based at least in part on the received information, when a next network data packet is to be received. In some cases, when the next network data packet is to be received is predicted using a machine learning model. In some cases, the information associated with the one or more network data packets comprises information associated with a current network data packet, and the process 1800 may also include receiving historical information associated with one or more network data packets, and outputting the indication of the DRX configuration based on the historical information associated with one or more network data packets and the information associated with the current network data packet. In some cases, the information associated with the one or more network data packets comprises at least one of average latency, packet arrival time, packet length, periodicity of packet arrival, or packet size information.

At operation 1806, process 1800 can include determining a discontinuous reception (DRX) configuration based on the prediction of when the next network data packet is to be received. At operation 1808, process 1800 can include outputting an indication of the DRX configuration for transmission to a device. In some aspects, the indication of the DRX configuration comprises a radio resource control (RRC) message. For example, the indication of the DRX configuration may include an RRC DRX configuration message, where the RRC DRX configuration message includes an indication of one or more values that are based on the prediction of when the next network data packet is to be received (e.g., as shown by the first option 1104 in FIG. 11). In another example, the RRC message may be separate from a RRC DRX configuration message, in which case the RRC DRX configuration message may include a pre-configured DRX configuration (e.g., as shown by the second option 1106 in FIG. 11).

In some cases, the wireless device comprises a user device. In some cases, outputting the indication of the DRX configuration comprises outputting, for transmission to a network entity, an indication to stop a DRX timer before expiration of the DRX timer. In some cases, the process 1800 can also include monitoring for a response to the indication to stop the DRX timer from the network entity during a next monitoring occasion, and based on a determination that the response to the indication to stop the DRX timer from the network entity was not received during the next monitoring occasion, stopping the DRX timer before expiration of the DRX timer. In some cases, the process 1800 can also include monitoring for a response to the indication to stop the DRX timer from the network entity during a next monitoring occasion, receiving the response to the indication to stop the DRX timer from the network entity, and stopping the DRX timer after expiration of the DRX timer. In some cases, outputting the indication of the DRX configuration for transmission comprises outputting, for transmission to a network entity, an indication to extend a DRX timer before expiration of the DRX timer. In some cases, the process 1800 further includes monitoring for a response to the indication to extend the DRX timer from the network entity during a next monitoring occasion, and based on a determination that the response to the indication to extend the DRX timer from the network entity was not received during the next monitoring occasion, extending the DRX timer. In some cases, the DRX timer comprises a DRX inactivity timer.

In some cases, the wireless device comprises a network entity. In some cases, the indication of the DRX configuration comprises an indication of when a user device can switch between different DRX cycle lengths. In some cases, the indication of the DRX configuration comprises an indication to stop a DRX short cycle of the user device. In some cases, the indication of the DRX configuration comprises an indication to disable a DRX short cycle of the user device. In some cases, the indication of the DRX configuration is output as one of a radio resource control (RRC) signaling, medium access control control element (MAC-CE) signaling, or level 1 signaling. In some cases, the indication of the DRX configuration comprises an indication to switch between a DRX short cycle and a DRX long cycle of the user device. In some cases, the indication of the DRX configuration comprises a value for at least one of a duration or length of a DRX cycle. In some cases, the process 1800 also includes monitoring errors between when the next network data packet is predicted to be received and when the next network data packet is received, determining the errors meet an error condition, and outputting an indication of a pre-configured DRX configuration for transmission to a user device based on the determination that the errors meet the error condition. In some cases, the error condition comprises a predefined threshold. In some cases, the process 1800 further includes determining that no data was transmitted to the user device during at least one of a predicted DRX on period or duration of a DRX inactivity timer; and wherein the error condition is based on the determination that no data was transmitted to the user device during at least one of a predicted DRX on period or duration of a DRX inactivity timer. In some cases, the process 1800 also includes determining that the errors no longer meet the error condition, and outputting the indication of the DRX configuration for transmission based on the determination that the errors no longer meet the error condition

In some examples, the processes described herein (e.g., process 1800 and/or other process described herein) may be performed by a computing device or apparatus (e.g., a UE or a base station). In another example, the process 1800 may be performed by the UE 104 of FIG. 1. In another example, the process 1800 may be performed by a base station 102 of FIG. 1

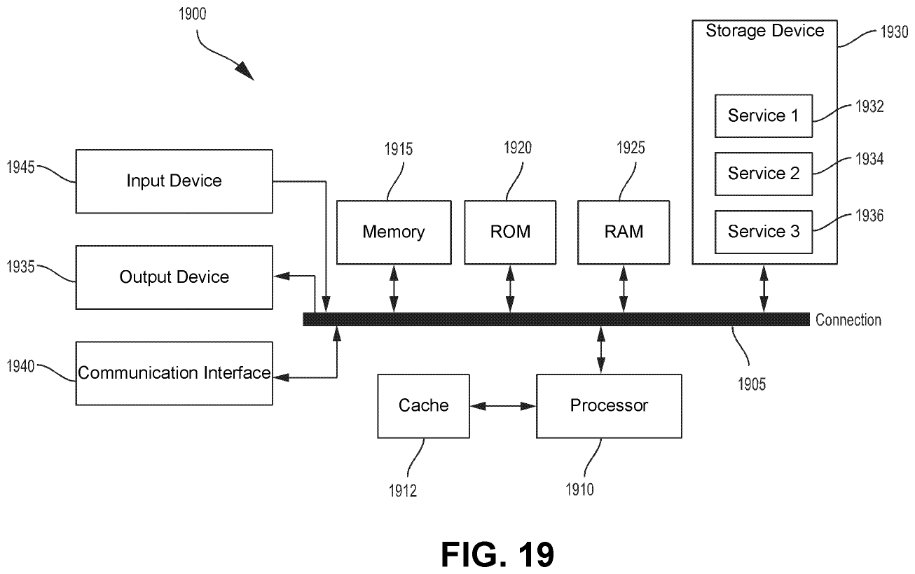

FIG. 19 is a diagram illustrating an example of a system for implementing certain aspects of the present technology. In particular, FIG. 19 illustrates an example of computing system 1900, which may be for example any computing device making up internal computing system, a remote computing system, a camera, or any component thereof in which the components of the system are in communication with each other using connection 1905. Connection 1905 may be a physical connection using a bus, or a direct connection into processor 1910, such as in a chipset architecture. Connection 1905 may also be a virtual connection, networked connection, or logical connection.

In some embodiments, computing system 1900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1900 includes at least one processing unit (CPU or processor) 1910 and connection 1905 that communicatively couples various system components including system memory 1915, such as read-only memory (ROM) 1920 and random access memory (RAM) 1925 to processor 1910. Computing system 1900 may include a cache 1912 of high-speed memory connected directly with, in close proximity to, or integrated as part of processor 1910.

Processor 1910 may include any general purpose processor and a hardware service or software service, such as services 1932, 1934, and 1936 stored in storage device 1930, configured to control processor 1910 as well as a special-purpose processor where software instructions are incorporated into the actual processor design. Processor 1910 may essentially be a completely self-contained computing system, containing multiple cores or processors, a bus, memory controller, cache, etc. A multi-core processor may be symmetric or asymmetric.

To enable user interaction, computing system 1900 includes an input device 1945, which may represent any number of input mechanisms, such as a microphone for speech, a touch-sensitive screen for gesture or graphical input, keyboard, mouse, motion input, speech, etc. Computing system 1900 may also include output device 1935, which may be one or more of a number of output mechanisms. In some instances, multimodal systems may enable a user to provide multiple types of input/output to communicate with computing system 1900.

Computing system 1900 may include communications interface 1940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1940 may also include one or more Global Navigation Satellite System (GNSS) receivers or transceivers that are used to determine a location of the computing system 1900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1930 may include software services, servers, services, etc., that when the code that defines such software is executed by the processor 1910, it causes the system to perform a function. In some embodiments, a hardware service that performs a particular function may include the software component stored in a computer-readable medium in connection with the necessary hardware components, such as processor 1910, connection 1905, output device 1935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. An apparatus for wireless communications, comprising: at least one memory; and at least one processor coupled to the memory and configured to: receive information associated with one or more network data packets; predict, based at least in part on the received information, when a next network data packet is to be received; determine a discontinuous reception (DRX) configuration based on the prediction of when the next network data packet is to be received; and output an indication of the DRX configuration for transmission to a device.

Aspects 2. The apparatus of claim 1, wherein the at least one processor is configured to predict when the next network data packet is to be received using a machine learning model.

Aspect 3. The apparatus of any of claims 1-2, wherein the information associated with the one or more network data packets comprises information associated with a current network data packet, and wherein the at least one processor is configured to: receive historical information associated with one or more network data packets; and output the indication of the DRX configuration based on the historical information associated with one or more network data packets and the information associated with the current network data packet.

Aspect 4. The apparatus of any of claims 1-3, wherein the information associated with the one or more network data packets comprises at least one of average latency, packet arrival time, packet length, periodicity of packet arrival, or packet size information.

Aspect 5. The apparatus of any of claims 1-4, wherein the indication of the DRX configuration comprises a radio resource control (RRC) message.

Aspect 6. The apparatus of claim 5, wherein the indication of the DRX configuration comprises an RRC DRX configuration message, and wherein the RRC DRX configuration message includes an indication of one or more values that are based on the prediction of when the next network data packet is to be received.

Aspect 7. The apparatus of claim 5, wherein the RRC message is separate from a RRC DRX configuration message, wherein the RRC DRX configuration message includes a pre-configured DRX configuration.

Aspect 8. The apparatus of any of claims 1-7, wherein the apparatus comprises a user device.

Aspect 9. The apparatus of any of claims 1-8, wherein, to output the indication of the DRX configuration for transmission, the at least one processor is configured to: output, for transmission to a network entity, an indication to stop a DRX timer before expiration of the DRX timer.

Aspect 10. The apparatus of claim 9, wherein the at least one processor is configured to: monitor for a response to the indication to stop the DRX timer from the network entity during a next monitoring occasion; and based on a determination that the response to the indication to stop the DRX timer from the network entity was not received during the next monitoring occasion, stopping the DRX timer before expiration of the DRX timer.

Aspect 11. The apparatus of any of claims 9-10, wherein the at least one processor is configured to: monitor for a response to the indication to stop the DRX timer from the network entity during a next monitoring occasion; receive the response to the indication to stop the DRX timer from the network entity; and stop the DRX timer after expiration of the DRX timer.

Aspect 12. The apparatus of any of claims 1-8, wherein, to output the indication of the DRX configuration for transmission, the at least one processor is configured to: output, for transmission to a network entity, an indication to extend a DRX timer before expiration of the DRX timer.

Aspect 13. The apparatus of claim 12, wherein the at least one processor is configured to: monitor for a response to the indication to extend the DRX timer from the network entity during a next monitoring occasion; and based on a determination that the response to the indication to extend the DRX timer from the network entity was not received during the next monitoring occasion, extending the DRX timer.

Aspect 14. The apparatus of any of claims 9-13, wherein the DRX timer comprises a DRX inactivity timer.

Aspect 15. The apparatus of any of claims 1-7, wherein the apparatus comprises a network entity.

Aspect 16. The apparatus of claim 15, wherein the indication of the DRX configuration comprises an indication of when a user device can switch between different DRX cycle lengths.

Aspect 17. The apparatus of claim 15, wherein the indication of the DRX configuration comprises an indication to stop a DRX short cycle of the user device.

Aspect 18. The apparatus of claim 15, wherein the indication of the DRX configuration comprises an indication to disable a DRX short cycle of the user device.

Aspect 19. The apparatus of claim 15, wherein the indication of the DRX configuration is output as one of a radio resource control (RRC) signaling, medium access control control element (MAC-CE) signaling, or level 1 signaling.

Aspect 20. The apparatus of claim 15, wherein the indication of the DRX configuration comprises an indication to switch between a DRX short cycle and a DRX long cycle of the user device.

Aspect 21. The apparatus of claim 15, wherein the indication of the DRX configuration comprises a value for at least one of a duration or length of a DRX cycle.

Aspect 22. The apparatus of any of claims 15-21, wherein the at least one processor is configured to: monitor errors between when the next network data packet is predicted to be received and when the next network data packet is received; determine the errors meet an error condition; and output an indication of a pre-configured DRX configuration for transmission to a user device based on the determination that the errors meet the error condition.

Aspect 23. The apparatus of claim 22, wherein the error condition comprises a predefined threshold.

Aspect 24. The apparatus of any of claims 22-23, wherein the at least one processor is configured to: determine that no data was transmitted to the user device during at least one of a predicted DRX on period or duration of a DRX inactivity timer; and wherein the error condition is based on the determination that no data was transmitted to the user device during at least one of a predicted DRX on period or duration of a DRX inactivity timer.

Aspect 25. The apparatus of any of claims 22-24, the at least one processor is configured to: determine that the errors no longer meet the error condition; and output the indication of the DRX configuration for transmission based on the determination that the errors no longer meet the error condition.

Aspect 26. A method for wireless communications by a wireless device, comprising: receiving information associated with one or more network data packets; predicting, based at least in part on the received information, when a next network data packet is to be received; determining a discontinuous reception (DRX) configuration based on the prediction of when the next network data packet is to be received; and outputting an indication of the DRX configuration for transmission to a device.

Aspect 27. The method of claim 26, wherein when the next network data packet is to be received is predicted using a machine learning model.

Aspect 28. The method of claim 26, wherein the information associated with the one or more network data packets comprises information associated with a current network data packet, and wherein the method further comprises: receiving historical information associated with one or more network data packets; and outputting the indication of the DRX configuration based on the historical information associated with one or more network data packets and the information associated with the current network data packet.

Aspect 29. The method of any of claims 26-28, wherein the information associated with the one or more network data packets comprises at least one of average latency, packet arrival time, packet length, periodicity of packet arrival, or packet size information.

Aspect 30. The method of any of claims 26-29, wherein the indication of the DRX configuration comprises a radio resource control (RRC) message.

Aspect 31. The method of claim 30, wherein the indication of the DRX configuration comprises an RRC DRX configuration message, and wherein the RRC DRX configuration message includes an indication of one or more values that are based on the prediction of when the next network data packet is to be received.

Aspect 32. The method of claim 30, wherein the RRC message is separate from a RRC DRX configuration message, wherein the RRC DRX configuration message includes a pre-configured DRX configuration

Aspect 33. The method of any of claims 26-32, wherein the wireless device comprises a user device.

Aspect 34. The method of claim 33, wherein outputting the indication of the DRX configuration comprises outputting, for transmission to a network entity, an indication to stop a DRX timer before expiration of the DRX timer.

Aspect 35. The method of claim 34, further comprises: monitoring for a response to the indication to stop the DRX timer from the network entity during a next monitoring occasion; and based on a determination that the response to the indication to stop the DRX timer from the network entity was not received during the next monitoring occasion, stopping the DRX timer before expiration of the DRX timer.

Aspect 36. The method of claim 34, further comprising: monitoring for a response to the indication to stop the DRX timer from the network entity during a next monitoring occasion; receiving the response to the indication to stop the DRX timer from the network entity; and stopping the DRX timer after expiration of the DRX timer.

Aspect 37. The method of claim 33, wherein outputting the indication of the DRX configuration for transmission comprises: outputting, for transmission to a network entity, an indication to extend a DRX timer before expiration of the DRX timer.

Aspect 38. The method of claim 37, further comprising: monitoring for a response to the indication to extend the DRX timer from the network entity during a next monitoring occasion; and based on a determination that the response to the indication to extend the DRX timer from the network entity was not received during the next monitoring occasion, extending the DRX timer.

Aspect 39. The method of any of claims 34-38, wherein the DRX timer comprises a DRX inactivity timer.

Aspect 40. The method of any of claims 26-32, wherein the wireless device comprises a network entity.

Aspect 41. The method of claim 40, wherein the indication of the DRX configuration comprises an indication of when a user device can switch between different DRX cycle lengths.

Aspect 42. The method of claim 41, wherein the indication of the DRX configuration comprises an indication to stop a DRX short cycle of the user device.

Aspect 43. The method of claim 41, wherein the indication of the DRX configuration comprises an indication to disable a DRX short cycle of the user device.

Aspect 44. The method of claim 41, wherein the indication of the DRX configuration is output as one of a radio resource control (RRC) signaling, medium access control control element (MAC-CE) signaling, or level 1 signaling.

Aspect 45. The method of claim 41, wherein the indication of the DRX configuration comprises an indication to switch between a DRX short cycle and a DRX long cycle of the user device.

Aspect 46. The method of claim 40, wherein the indication of the DRX configuration comprises a value for at least one of a duration or length of a DRX cycle.

Aspect 47. The method of any of claims 40-46, further comprising: monitoring errors between when the next network data packet is predicted to be received and when the next network data packet is received; determining the errors meet an error condition; and outputting an indication of a pre-configured DRX configuration for transmission to a user device based on the determination that the errors meet the error condition.

Aspect 48. The method of claim 47, wherein the error condition comprises a predefined threshold.

Aspect 49. The method of claim 47, further comprising: determining that no data was transmitted to the user device during at least one of a predicted DRX on period or duration of a DRX inactivity timer; and wherein the error condition is based on the determination that no data was transmitted to the user device during at least one of a predicted DRX on period or duration of a DRX inactivity timer.

Aspect 40. The method of any of claims 47-49, further comprising: determining that the errors no longer meet the error condition; and outputting the indication of the DRX configuration for transmission based on the determination that the errors no longer meet the error condition.

Aspect 51. A non-transitory computer-readable storage medium comprising instructions stored thereon which, when executed by at least one processor, causes the at least one processor to perform operations according to any of claims 26 to 50.

Aspect 52. An apparatus for wireless communications comprising one or more means for performing operations according to any of claims 26 to 50.

1. An apparatus for wireless communications, comprising:
at least one memory; and
at least one processor coupled to the at least one memory and configured to:
receive information associated with one or more network data packets;
predict, based at least in part on the received information, when a next network data packet is to be received;
determine a discontinuous reception (DRX) configuration based on the prediction of when the next network data packet is to be received; and
output an indication of the DRX configuration for transmission to a device.

2. The apparatus of claim 1, wherein the at least one processor is configured to predict when the next network data packet is to be received using a machine learning model.

3. The apparatus of claim 1, wherein the information associated with the one or more network data packets comprises information associated with a current network data packet, and wherein the at least one processor is configured to:
receive historical information associated with one or more network data packets; and output the indication of the DRX configuration based on the historical information associated with one or more network data packets and the information associated with the current network data packet.

4. The apparatus of claim 1, wherein the information associated with the one or more network data packets comprises at least one of average latency, packet arrival time, packet length, periodicity of packet arrival, or packet size information.

5. (canceled)

6. The apparatus of claim 1, wherein the indication of the DRX configuration comprises a radio resource control (RRC) an RRC DRX configuration message, and wherein the RRC DRX configuration message includes an indication of one or more values that are based on the prediction of when the next network data packet is to be received.

7. (canceled)

8. The apparatus of claim 1, wherein the apparatus comprises a user device.

9. The apparatus of claim 8, wherein, to output the indication of the DRX configuration for transmission, the at least one processor is configured to:
output, for transmission to a network entity, an indication to stop a DRX timer before expiration of the DRX timer.

10. The apparatus of claim 9, wherein the at least one processor is configured to:
monitor for a response to the indication to stop the DRX timer from the network entity during a next monitoring occasion; and
based on a determination that the response to the indication to stop the DRX timer from the network entity was not received during the next monitoring occasion, stopping the DRX timer before expiration of the DRX timer.

11. The apparatus of claim 9, wherein the at least one processor is configured to:
monitor for a response to the indication to stop the DRX timer from the network entity during a next monitoring occasion;
receive the response to the indication to stop the DRX timer from the network entity; and
stop the DRX timer after expiration of the DRX timer.

12. The apparatus of claim 8, wherein, to output the indication of the DRX configuration for transmission, the at least one processor is configured to:
output, for transmission to a network entity, an indication to extend a DRX timer before expiration of the DRX timer.

13. The apparatus of claim 12, wherein the at least one processor is configured to:
monitor for a response to the indication to extend the DRX timer from the network entity during a next monitoring occasion; and
based on a determination that the response to the indication to extend the DRX timer from the network entity was not received during the next monitoring occasion, extending the DRX timer.

14. The apparatus of claim 9, wherein the DRX timer comprises a DRX inactivity timer.

15. The apparatus of claim 1, wherein the apparatus comprises a network entity.

16. The apparatus of claim 15, wherein the indication of the DRX configuration comprises an indication of when a user device can switch between different DRX cycle lengths.

17. The apparatus of claim 16, wherein the indication of the DRX configuration comprises an indication to stop a DRX short cycle of the user device.

18. (canceled)

19. (canceled)

20. The apparatus of claim 15, wherein the indication of the DRX configuration comprises an indication to switch between a DRX short cycle and a DRX long cycle of the user device.

21. The apparatus of claim 15, wherein the indication of the DRX configuration comprises a value for at least one of a duration or length of a DRX cycle.

22. The apparatus of claim 15, wherein the at least one processor is configured to:
monitor errors between when the next network data packet is predicted to be received and when the next network data packet is received;
determine the errors meet an error condition; and
output an indication of a pre-configured DRX configuration for transmission to a user device based on the determination that the errors meet the error condition.

23. The apparatus of claim 22, wherein the error condition comprises a predefined threshold.

24. (canceled)

25. (canceled)

26. A method for wireless communications by a wireless device, comprising:
receiving information associated with one or more network data packets;
predicting, based at least in part on the received information, when a next network data packet is to be received;
determining a discontinuous reception (DRX) configuration based on the prediction of when the next network data packet is to be received; and
outputting an indication of the DRX configuration for transmission to a device.

27-52. (canceled)
